(19) United States
(12) Patent Application Publication
(10) Pub. No.: US 2016/0218835 A1
(43) Pub. Date: Jul. 28, 2016

(54) METHOD AND APPARATUS FOR CONSTITUTING FEEDBACK SIGNAL FOR HARQ

(71) Applicant: Electronics and Telecommunications Research Institute, Daejeon (KR)

(72) Inventors: Sung woo CHOI, Daejeon (KR); Junhyeong KIM, Daejeon (KR)

(21) Appl. No.: 15/006,660

(22) Filed: Jan. 26, 2016

(30) Foreign Application Priority Data
Jan. 26, 2015 (KR) 10-2015-0012276
Jan. 25, 2016 (KR) 10-2016-0008797

(51) Int. Cl. H04L 1/18; H04L 1/00; H04L 12/26

(52) U.S. Cl. CPC H04L 1/1812; H04L 43/0847; H04L 1/0041

(57) ABSTRACT

A method and an apparatus for constituting a feedback signal for hybrid automatic repeat request (HARQ) are provided. Arbitrary two feedback states of feedback states which may occur for two frames may be integrally processed into one state. In addition, the feedback signal including information indicating the feedback state determined for the two frames is constituted and transmitted.

### CROSS-REFERENCE TO RELATED APPLICATION

This application claims priority to and the benefit of Korean Patent Application Nos. 10-2015-0012276 and 10-2016-0008797 filed in the Korean Intellectual Property Office on Jan. 26, 2015 and Jan. 25, 2016, the entire contents of which are incorporated herein by reference.

### BACKGROUND OF THE INVENTION

(a) Field of the Invention

The present invention relates to a method and an apparatus for constituting a feedback signal for hybrid automatic repeat request (HARQ).

(b) Description of the Related Art

In recent, mobile communication attempts to improve transfer performance using hybrid automatic repeat request (HARQ). The HARQ has a form in which forward error correction (FEC) for correcting error and ARQ are combined. In an ordinary ARQ, a transmitting end adds error detection code such as cyclic redundancy check (CRC) to data to be transmitted, and a receiving end transmits an acknowledgement (ACK) message or a negative ACK (NACK) message. Here, if the receiving end detects the error from a received signal using the error detection code, the receiving end requests signal retransmission to the transmitting end, and the transmitting end retransmits the corresponding signal. By the above-mentioned operations, transmission error may be removed.

In HARQ, the transmitting end encodes data with FEC, and transmits-systematic bits and parity bits. In addition, when the NACK is received from the receiving end, the systematic bits and the parity bits which were previously transmitted by the transmitting end may be retransmitted, or additional parity bits may be transmitted. According to a soft combining method among HARQ methods, erroneous packets are stored rather than immediately discarded and are then combined with the retransmitted packet. Then, it is determined whether or not there is error by again performing CRC. Here, a HARQ operation may be varied depending on a kind of errors of a received frame. The error includes a NACK state in which CRC error occurs, and a discontinuous transmission (DTX) state in which ACK/NACK is not determined. DTX occurs when the receiving end does not sense the transmitted packet for an allocated time. The HARQ has an advantage that it allows transmission efficiency to be higher than that of ARQ when a transmission line is bad.

Meanwhile, as a multi-band is used for a large capacity transmission, or communication systems using time division duplex (TDD) in an aspect of frequency efficiency are much increased, a HARQ feedback for a multi-frame is required. However, as an amount of feedback information is increased, only efficiency for a feedback channel has been considered. As a result, a phenomenon that does not sufficiently enjoy an effect of the HARQ occurs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for constituting a feedback signal having advantages of improving performance of HARQ using minimal additional information, in communication with a transmission error feedback for a multi-frame

An exemplary embodiment of the present invention provides a method for constituting a feedback signal for hybrid automatic repeat request (HARQ), including: integrally processing arbitrary two feedback states of feedback states which occur for two frames into one state; and constituting and transmitting the feedback signal including information indicating the feedback state determined for the two frames.

The integrally processing may include: binding and processing two frames into one when a feedback mode is an expansion feedback mode and a feedback for three or more frames is performed; and integrally processing arbitrary two feedback states of feedback states which occur for each of the two frames bounded into one into one state.

The constituting and transmitting of the feedback signal may include: mapping a feedback state determined for every the two frames to information of 3 bits; and constituting and transmitting the feedback signal including all of the information of 3 bits mapped to every the two frames.

In the integrally processing, a first state in which a feedback type for one frame of the two frames is discontinuous transmission (DTX) and the feedback type for the remaining frame is negative acknowledgement (NACK), and a second state in which the feedback type for one frame of the two frames is DTX and the feedback type for the remaining frame is DTX may be integrally processed into one state.

In the integrally processing, the first state and the second state may be integrally processed into a state in which the feedback type for one frame is DTX and the feedback type for the remaining frame is NACK/DTX.

The method may further include constituting and transmitting the feedback signal including information indicating the feedback state determined for the two frames when a feedback mode is an expansion feedback mode and a feedback for two frames is performed.

The constituting and transmitting of the feedback signal including information indicating the feedback state determined for the two frames when a feedback mode is an expansion feedback mode and a feedback for two frames is performed may include constituting and transmitting the feedback signal when the feedback state determined for the two frames is not a set state.

The set state may be a state in which the feedback type for one frame of the two frames is DTX and the feedback type for the remaining frame is DTX.

The constituting and transmitting of the feedback signal when the feedback state determined for the two frames is not a set state may include mapping the determined feedback state to information of 3 bits; and transmitting the feedback signal including the information of 3 bits.

Another embodiment of the present invention provides an apparatus for constituting a feedback signal for hybrid automatic repeat request (HARQ), including: a radio frequency converter transmitting and receiving a signal through an antenna; and a processor connected to the radio frequency converter and constituting a feedback signal, wherein the processor includes a mode confirming unit determining a feedback mode; a frame type confirming unit confirming a feedback type for HARQ for each frame; a state integrated processing unit integrally processing arbitrary two feedback states of feedback states which occur for two frames into one state; and a signal constituting unit constituting the feedback signal including information indicating the feedback state determined for the two frames.

When the feedback mode is an expansion feedback mode and a feedback for three or more frames is performed, the state integrated processing unit may bind and process two frames into one and integrally process arbitrary two states of feedback states which occur for each of the two frames bounded into one into one state.

The state integrated processing unit may integrally process a first state in which a feedback type for one frame of the two frames is DTX and the feedback type for the remaining frame is NACK, and a second state in which the feedback type for one frame of the two frames is DTX and the feedback type for the remaining frame is DTX into one state.

The state integrated processing unit may integrally process the first state and the second state into a state in which the feedback type for one frame is DTX and the feedback type for the remaining frame is NACK/DTX.

The signal constituting unit may map the determined feedback state to information of 3 bits, and constitute the feedback signal including the information of 3 bits.

When the feedback mode is an expansion feedback mode and a feedback for two frames is performed, if the feedback state determined for the two frames is not a set state, the signal constituting unit may constitute the feedback signal for the two frames.

The set state may be a state in which the feedback type for one frame of the two frames is DTX and the feedback type for the remaining frame is DTX.

### BRIEF DESCRIPTION OF THE DRAWINGS

FIG. 1 is a flowchart illustrating a method for constituting a feedback signal according to an exemplary embodiment of the present invention.

FIG. 2 is a structural diagram of an apparatus for constituting a feedback signal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

Hereinafter, a method and an apparatus for constituting a feedback signal according to an exemplary embodiment of the present invention will be described with reference to the accompanying drawings.

In a mobile communication system (e.g., a long term evolution (LTE) system), a hybrid automatic repeat request (HARQ) operation is performed as follows.

A base station transmits downlink data through a downlink channel, that is, a physical downlink shared channel (PDSCH), a terminal transmits HARQ-acknowledgement (ACK) according to a reception of the downlink data through an uplink control channel, that is, a physical uplink control channel (PUCCH). The PDSCH may be received when the terminal receives a physical downlink control channel (PDCCH) having information for the PDSCH without error. A FEC encoding of the PDSCH is configured of a systematic bit and a parity bit. When the terminal does not receive the PDCCH, the terminal determines a discontinuous transmission (DTX) state and does not transmit anything through the PUCCH. That is, the terminal may not transmit information about whether or not PDSCH data is successfully received.

The base station detects three states of ACK, negative ACK (NACK), and DTX for the downlink data through the PUCCH. The ACK means a state in which data is received without cyclic redundancy check (CRC) error, the NACK means a state in which the CRC error occurs, and the DTX means a state in which transmitted packets are not sensed for an allocated time, so the ACK/NACK may not be determined. The base station may differently treat the NACK and the DTX. In the case of NACK, the base station may retransmit additional parity bits for incremental redundancy. In the case of DTX, since the terminal does not receive the packets from the first, the base station retransmits the systematic bit and the parity bit instead of the additional parity bits.

In the LTE system, the number of PDSCH data are transmitted through the PDCCH. A receiver compares the number of PDSCH data with the numbers which are already received to determine whether or not a missing frame occurs. In the case of time division duplexing (TDD), when the missing frame occurs, the NACK is transmitted upon performing a HARQ-ACK feedback. Here, not classifying the NACK and the DTX is not using an advantage of HARQ, which comes from soft combining scheme, but has an advantage that additional feedback bits or resources are not required.

According to an exemplary embodiment of the present invention, a feedback signal including minimal information is constituted upon performing the HARQ feedback, thereby supporting a hybrid-ARQ scheme. According to an exemplary embodiment of the present invention, it is assumed that HARQ information on a plurality of frames is transmitted using one feedback channel.

According to an exemplary embodiment of the present invention, the feedback is performed in two modes. Specifically, a feedback mode includes a first feedback mode and a second feedback mode and transmits the feedback signal indicating a feedback type for the downlink data, wherein the feedback type is one of ACK, NACK, and DTX.

The first feedback mode may be referred to as an ordinary feedback mode, where feedback information of 1 bit, that is, HARQ-ACK or HARQ-NACK/DTX is assigned to each one downlink (DL) frame. For a plurality of frames, the feedback information may be assigned to every frame. The assigned feedback information is as shown in Table 1.

TABLE 1

| Acknowledgement | |
|---|---|
| for DL frame 1 | bit mapping |
| ACK | 1 |
| NACK/DTX | 0 |

As shown in Table 1, the feedback information of 1 bit is assigned according to the first feedback mode and the feedback information includes ACK and NACK/DTX. Here, in the case of NACK/DTX, “0” is mapped, such that NACK/DTX are not separately classified. In the first feedback mode, upon performing a feedback for n frames, a feedback signal is configured of n bits.

The second feedback mode may be referred to as an expansion feedback mode and is used when a feedback is performed for two or more frames. When the feedback for the two frames is performed, the feedback information for the respective frames is as shown in Table 2.

TABLE 2

| Acknowledgement | Acknowledgement |
|---|---|
| for DL frame 1 | for DL frame 2 |
| ACK | ACK |
| ACK | NACK |
| ACK | DTX |
| NACK | ACK |
| NACK | NACK |
| NACK | DTX |
| DTX | ACK |
| DTX | NACK |
| DTX | DTX |

As shown in Table 2, the feedback information that may occur for the two frames includes a feedback type for one frame (referred to as a first feedback type, for convenience of explanation) and a feedback type for the remaining frame (referred to as a second feedback type, for convenience of explanation). The feedback information is formed of a pair of first feedback type and second feedback type, and the feedback information for the two frames may be in nine states as shown in Table 2. Here, NACK and DTX are separately classified.

The feedback information for the remaining eight states except for a state of “DTX-DTX” of Table 2 may be formed of 3 bits. In addition, in the case in which the feedback type for the DL frame 1 and the feedback type for the DL frame 2 are “DTX-DTX”, if the feedback signal is not transmitted, the nine states are eventually expressed by 3 bits.

When one frame has three feedback types (i.e., ACK, NACK, and DTX), if the feedback is performed for n frames, the number of cases of 3ⁿ occurs. Bits of the feedback signal may be set to include all the number of cases. For example, when the feedback is performed for three frames, the feedback signal is set to 5 bits, and when the feedback is performed for four frames, the feedback signal is set to 7 bits. However, in the case in which the bits of the feedback signal are set as described above, bit waste occurs as compared to actually required information. When the feedback is performed for the three frames, the number of cases of 27 occurs, and when the feedback is performed for the four frames, the number of cases of 81 occurs. Since the feedback signal is configured to include all feedback cases, a case in which an arbitrary bit sequence among bit sequences of the feedback signal is not assigned to a feedback state occurs. However, according to an exemplary embodiment of the present invention, the feedback information is formed of 3 bits while constituting the feedback signal for every the two frames, such that the feedback signal for four frames is constituted of 6 bits. Thus, in compare with the feedback signal of 7 bits which were required when a total number of feedback cases is included, the feedback signal is efficiently constituted.

Meanwhile, in the case in which the feedback signal of 3 bits is transmitted when the feedback for the two frames is performed, in the case of “DTX-DTX”, if it is determined that the feedback signal is not transmitted, that is, an UL control frame is not transmitted, the feedback for the two frames may be performed by the feedback signal of 3 bits. However, when the feedback signal for three or more frames is transmitted, in all other cases except for a case in which feedback information for all frames is DTX, it is required that the feedback information is transferred through the UL feedback channel.

According to an exemplary embodiment of the present invention, when an expansion feedback is performed, in the case in which the feedback signal for the three or more frames is transmitted, the feedback information on the two frames is bound into one to be processed, such that the feedback signal is constituted. That is, when the feedback for the three or more frames is performed, the feedback information is assigned to every the two frames and the entirety of feedback information assigned to every the two frames is summed to constitute the feedback signal.

By processing the feedback information on the two frames with one binding, the feedback information formed of 3 bits as follows is constituted.

TABLE 3

| Acknowledgement | Acknowledgement | Bitmapping |
|---|---|---|
| for DL frame 1 | for DL frame 2 | (Example) |
| ACK | ACK | 000 |
| ACK | NACK | 001 |
| ACK | DTX | 010 |
| NACK | ACK | 011 |
| NACK | NACK | 100 |
| NACK | DTX | 101 |
| DTX | ACK | 110 |
| DTX | NACK/DTX | 111 |

When the feedback for the two frames is performed, the nine states occur as shown in Table 2. In this case, arbitrary two states are bound into one state, which may be expressed by the feedback information of 3 bits as shown in Table 3. For example, in Table 2, a state of “DTX-NACK” and a state of “DTX-DTX” are bound into one state, which is processed as a state such as “DTX-NACK/DTX” in a last row of Table 3. In addition, the feedback information formed of 3 bits is assigned to the nine states as shown in Table 3.

Meanwhile, in the case of “DTX-NACK/DTX” of Table 3, it may be appreciated that ambiguity exists in feedback information on the DL frame 2. That is, it may be ambiguous whether a state of the DL frame 2 is “NACK” or “”DTX”. However, the base station may reduce the number of cases in which an ambiguous situation occurs, using a scheduling. For example, the base station may select a time slot of DL depending on a size of DL data, upon performing the scheduling. When the DL frame is allocated using the selected time slot, if a frame that does not have ambiguity in a binding of the frames, that is, the DL frame 1 is first allocated, an occurrence of an ambiguous state may be reduced.

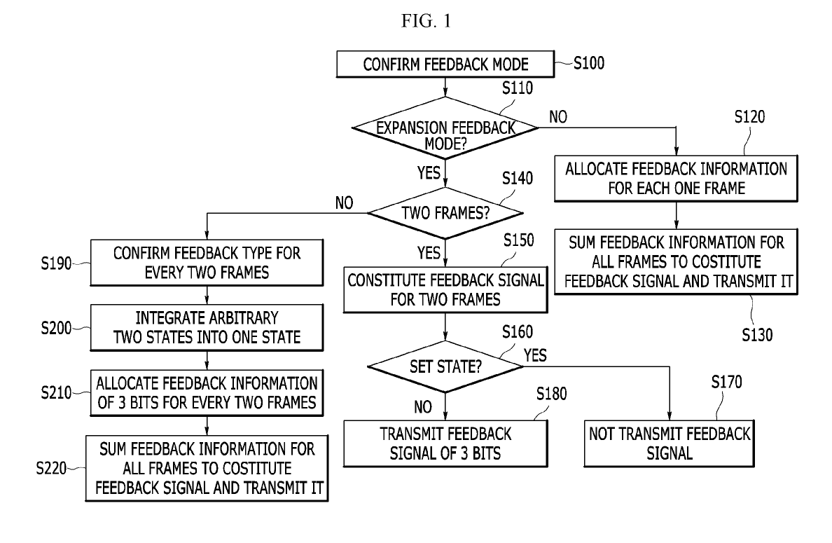

FIG. 1 is a flowchart illustrating a method for constituting a feedback signal according to an exemplary embodiment of the present invention.

The base station informs the terminal of the feedback mode. That is, the base station informs whether or not the feedback mode is the ordinary feedback mode or the expansion feedback mode.

The terminal confirms the feedback mode (S100), and performs the feedback according to the confirmed feedback mode.

In the case in which the feedback mode is the ordinary feedback mode, feedback information of 1 bit is assigned to every one frame (S110, S120). In the case of ordinary feedback mode, feedback information on one frame is classified into two types of ACK and NACK/DTX, and the feedback information of 1 bit corresponds to the feedback information on ACK or NACK/DTX. The terminal sums the feedback information of all frames to constitute a feedback signal and transmits the constituted feedback signal to the base station (S130).

In the case of expansion feedback mode, the terminal assigns the feedback information in a unit of two frames. In the expansion feedback mode, the feedback type for one frame is classified into three types of ACK, NACK, and DTX, and nine states occur for two frames.

First, when the feedback for the two frames is performed (S140), the feedback signal for the two frames is constituted (S150). In addition, in the case in which the feedback type is a set state, that is, in the case of “DTX-DTX” in which the feedback type for a first frame is DTX and the feedback type for a second frame is DTX (S160), the terminal does not transmit the feedback signal (S170). In addition, the terminal transmits the feedback signal only for the remaining states (eight states) except for the set state, and the feedback signal is formed of 3 bits (S180).

Meanwhile, when the feedback for three or more frames is performed in the expansion feedback mode, the feedback for two frames is bounded into one binding, thereby assigning the feedback information. First, a feedback type is confirmed for each binding (S190).

In the case of the feedback for one binding, two states of nine states which may occur are integrated into one state, such that a total of eight states are constituted. For example, a state of “DTX-NACK” in which the feedback type for the first frame is DTX and the feedback type for the second frame is NACK, and a state of “DTX-DTX” in which the feedback type for the first frame is DTX and the feedback type for the second frame is DTX are integrated into one state, that is, a state such as “DTX-NACK/DTX” (S200).

In addition, a total of eight feedback states including the integrated state are mapped to 3 bits, such that the feedback information of 3 bits is assigned to every the two frames (S210). The terminal sums the feedback information assigned to every the two frame for all frame to constitute the feedback signal and transmit the constituted feedback signal (S220).

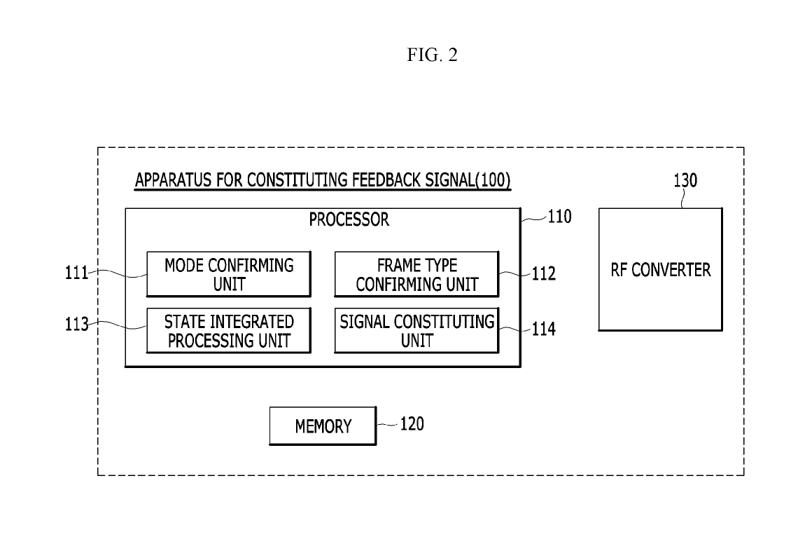

FIG. 2 is a structural diagram of an apparatus for constituting a feedback signal according to an exemplary embodiment of the present invention.

As shown in FIG. 2, an apparatus 100 for constituting a feedback signal according to an exemplary embodiment of the present invention includes a processor 110, a memory 120, and a radio frequency (RF) converter 130. The processor 110 may be constituted to implement the method described based on FIG. 1. Hereinafter, a detailed description of portions similar to those of the method described above will be omitted.

To this end, the processor 110 includes a mode confirming unit 111, a frame type confirming unit 112, a state integrated processing unit 113, and a signal constituting unit 114.

The mode confirming unit 111 is configured to confirm whether or not the feedback mode is the ordinary feedback mode or the expansion feedback mode based on information transmitted from the base station.

The frame type confirming unit 112 is configured to confirm the feedback type (ACK, NACK, DTX) for received downlink data. The frame type confirming unit 112 confirms the frame type for each one frame in the case of the ordinary feedback mode and confirms the frame type for each a plurality of frames in the case of the expansion feedback mode. In the case of the expansion feedback mode, the frame type confirming unit 112 may confirm the frame type for each of the two frames, and even in the case of three or more frames, the frame type confirming unit 112 processes the two frames into one binding, thereby confirming the frame type for each of the two frames.

In the case of the expansion feedback mode, when the feedback for the three or more frames is performed, the state integrated processing unit 113 is configured to integrally process arbitrary two states into one state. For example, the state integrated processing unit 113 integrates a state of “DTX-NACK” and a state of “DTX-DTX” into one state, that is, “DTX-NACK/DTX”, and processes states which may occur for the two frames into a total of eight.

The signal constituting unit 114 is configured to constitute the feedback signal. The signal constituting unit 114 may constitute the feedback signal, based on information provided from the frame type confirming unit 112 and information provided from the state integrated processing unit 113. In the case of the ordinary feedback mode, the signal constituting unit 114 assigns feedback information of 1 bit to every a frame and sums the feedback information as many as the number of frames to constitute the feedback signal. In the ordinary feedback mode, the once feedback signal transmitted for a plurality of frames includes feedback information of each frame by 1 bit. In the case of the expansion feedback mode, feedback information of 3 bits is assigned to every the two frame, and the feedback information as many as the number of bindings of the two frames is summed to generate the feedback signal. In the expansion feedback mode, the once feedback signal transmitted for the plurality of frames includes feedback information of 3 bits assigned to every two frames.

The memory 120 is connected to the processor 110 and stores various information associated with an operation of the processor 110. The memory 120 may be internal or external of the processor, and may be connected to the processor by various means which are already known. The memory is volatile or non-volatile storing medium of various types. For example, memory may include a read-only memory (ROM) or a random access memory (RAM).

The RF converter 130 is connected to the processor and transmits or receives a radio signal. The RF converter 130 transmits the feedback signal transferred from the processor 110.

According to an embodiment of the present invention, when HARQ-ACK is transmitted through one feedback channel for a plurality of frames, the feedback signal may be constituted using minimal additional bits. As a result, an advantage of HARQ-ACK may be maximally utilized. Further, the feedback signal is more effectively constituted in data transmission using the multi-band and a system having a large amount of feedback information such as a TDD scheme, thereby making it possible to perform the feedback.

The above-mentioned exemplary embodiments of the present invention are not implemented only by an apparatus and/or method described above. Alternatively, the above-mentioned exemplary embodiments may be embodied by a program performing functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for constituting a feedback signal for hybrid automatic repeat request (HARQ), the method comprising:
integrally processing arbitrary two feedback states of feedback states which occur for two frames into one state; and
constituting and transmitting the feedback signal including information indicating the feedback state determined for the two frames.

2. The method of claim 1, wherein the integrally processing includes:
binding and processing two frames into one when a feedback mode is an expansion feedback mode and a feedback for three or more frames is performed; and
integrally processing arbitrary two feedback states of feedback states which occur for each of the two frames bounded into one into one state.

3. The method of claim 2, wherein the constituting and transmitting of the feedback signal includes:
mapping a feedback state determined for every the two frames to information of 3 bits; and
constituting and transmitting the feedback signal including all of the information of 3 bits mapped to every the two frames.

4. The method of claim 2, wherein in the integrally processing, a first state in which a feedback type for one frame of the two frames is discontinuous transmission (DTX) and the feedback type for the remaining frame is negative acknowledgement (NACK), and a second state in which the feedback type for one frame of the two frames is DTX and the feedback type for the remaining frame is DTX are integrally processed into one state.

5. The method of claim 4, wherein in the integrally processing, the first state and the second state are integrally processed into a state in which the feedback type for one frame is DTX and the feedback type for the remaining frame is NACK/DTX.

6. The method of claim 1, further comprising:
constituting and transmitting the feedback signal including information indicating the feedback state determined for the two frames when a feedback mode is an expansion feedback mode and a feedback for two frames is performed.

7. The method of claim 6, wherein the constituting and transmitting of the feedback signal including information indicating the feedback state determined for the two frames when a feedback mode is an expansion feedback mode and a feedback for two frames is performed includes
constituting and transmitting the feedback signal when the feedback state determined for the two frames is not a set state.

8. The method of claim 7, wherein the set state is a state in which the feedback type for one frame of the two frames is DTX and the feedback type for the remaining frame is DTX.

9. The method of claim 7, wherein the constituting and transmitting of the feedback signal when the feedback state determined for the two frames is not a set state includes
mapping the determined feedback state to information of 3 bits; and
transmitting the feedback signal including the information of 3 bits.

10. An apparatus for constituting a feedback signal for hybrid automatic repeat request (HARQ), the apparatus comprising:
a radio frequency converter transmitting and receiving a signal through an antenna; and
a processor connected to the radio frequency converter and constituting a feedback signal,
wherein the processor includes
a mode confirming unit determining a feedback mode;
a frame type confirming unit confirming a feedback type for HARQ for each frame;
a state integrated processing unit integrally processing arbitrary two feedback states of feedback states which occur for two frames into one state; and
a signal constituting unit constituting the feedback signal including information indicating the feedback state determined for the two frames.

11. The apparatus of claim 10, wherein when the feedback mode is an expansion feedback mode and a feedback for three or more frames is performed, the state integrated processing unit binds and processes two frames into one and integrally processes arbitrary two states of feedback states which occur for each of the two frames bounded into one into one state.

12. The apparatus of claim 11, wherein the state integrated processing unit integrally processes a first state in which a feedback type for one frame of the two frames is DTX and the feedback type for the remaining frame is NACK, and a second state in which the feedback type for one frame of the two frames is DTX and the feedback type for the remaining frame is DTX into one state.

13. The apparatus of claim 12, wherein the state integrated processing unit integrally processes the first state and the second state into a state in which the feedback type for one frame is DTX and the feedback type for the remaining frame is NACK/DTX.

14. The apparatus of claim 10, wherein the signal constituting unit maps the determined feedback state to information of 3 bits, and constitutes the feedback signal including the information of 3 bits.

15. The apparatus of claim 14, wherein when the feedback mode is an expansion feedback mode and a feedback for two frames is performed, if the feedback state determined for the two frames is not a set state, the signal constituting unit constitutes the feedback signal for the two frames.

16. The apparatus of claim 15, wherein the set state is a state in which the feedback type for one frame of the two frames is DTX and the feedback type for the remaining frame is DTX.
